(19) United States
(12) Patent Application Publication
(10) Pub. No.: US 2024/0183328 A1
(43) Pub. Date: Jun. 6, 2024

(54) SYSTEM AND METHOD FOR FILTERING INTAKE AIR OF A CHAINSAW

(71) Applicant: Joseph Berto, Shady Cove, OR (US)

(72) Inventor: Joseph Berto, Shady Cove, OR (US)

(21) Appl. No.: 18/529,444

(22) Filed: Dec. 5, 2023

Related U.S. Application Data
(60) Provisional application No. 63/386,245, filed on Dec. 6, 2022.

(51) Int. Cl. F02M 35/024; B01D 46/00; B01D 46/10

(52) U.S. Cl. CPC F02M 35/024; B01D 46/0004; B01D 46/10

(57) ABSTRACT

A method for filtering and delivering air to an engine of a chainsaw. The method includes sealing a foam element against the inner surfaces between a filter cover and faceplate of a chainsaw, including the cage and faceplate intake structure and a cage, the sealing comprising squishing a foam material against one or more surfaces of the inner structures, and a cover designed to enhance airflow to an intake plenum.

### CROSS-REFERENCES TO RELATED APPLICATIONS

This application claims priority to U.S. Provisional Patent Application No. 63/386,245 filed on Dec. 6, 2022, the entire content of which is incorporated herein by reference.

### FIELD OF THE DISCLOSURE

The present disclosure relates to a system and method for filtering intake air of a chainsaw, and more particularly, used for filtering air which is delivered to a carburetor or fuel injection body of an engine such as chainsaw engine, and also a cover designed to provide maximum intake airflow through enlarged air cavities.

### BACKGROUND

Small gasoline engines power a wide variety of lawn and garden equipment such as lawn mowers, lawn tractors, chain saws, and so forth. In such engines, an air cleaner filters out grit from air entering a carburetor or fuel injection body and prevents dirt from getting into the engine, where it would cause excessive wear of moving parts. The air cleaner may have one or more filter elements which must be cleaned or replaced periodically. For instance, most manufacturers suggest cleaning or replacing the filter after every 25 hours to 50 hours of engine operation, but if the engine is operated in an unusually dusty or sandy area, service of the air cleaner should be performed at even shorter intervals.

Air cleaners typically include paper, foam, or metal air filters. Such filters eventually become clogged, making the engine difficult to start and may cause the engine to stall, run hesitantly, overheat, or allow dirty air to bypass filtration completely. Chainsaw filters (i.e., saw filters) can clog after being used for less than 10 hours.

Most air filters for chainsaw engines are located toward the top or rear of the engine, and are either attached directly to the carburetor or connected to it by a short adapter.

Air filters can include a metal housing having a lower wall with openings therethrough, a foam filter supported within the housing, and a pipe passing through the foam filter with a lower end of the pipe in fluid communication with an opening through the bottom wall of the housing. The foam filter overlaps the upper edge of the housing, and a cover clamps the foam filter against the housing. Air enters the openings in the lower surface of the housing, passes upwardly through the air filter and then downward through the pipe and into the carburetor.

Conventional air filters can include a paper element and a foam sleeve fitted around the paper element. This type of filter includes a lower plate having an opening therethrough in fluid communication with the carburetor and a cylindrical cover which clamps the foam sleeve and paper element against the lower plate such that air passes through an opening between the cover and the lower plate, passes through the foam sleeve, then through the paper element and then through the opening in the lower plate.

The air filters described above can include a bolt passing through the cover for purposes of attaching the cover to the air filter assembly. With such arrangements, dirt can find its way through the opening in the cover and lead to engine problems. Accordingly, there exists a need in the art for an air filter assembly which eliminates the problem of dirt entering through the attachment point of the cover of the air filter assembly.

### SUMMARY

In consideration of the above issues, it would be desirable to have a system and method for filtering intake air of chainsaw with an air filter assembly, which includes a filter configured to clean air for an engine of a chainsaw, and a filter cover. The filter cover can include a front panel, a pair of side panels, an upper panel, and a lower panel, the front panel including a recess configured to receive a locking nut, the upper panel including a pair of outer portions and a center portion extending from the front panel with a rounded edge, an inner weather and debris baffle configured to protect the filter element from extending from underneath the upper panel, and wherein the inner weather and debris baffle has a width of at least equal to or greater than a width of the upper panel from an upper edge of the front panel to a free end of the upper panel, the width of the inner lid extending from underneath the upper panel and away from the upper panel.

A method for filtering air for an engine of a chainsaw, the method comprising: sealing a foam element against an inner surface of a filter cover, the sealing comprising squishing a foam material against one or more surfaces of the inner surface of the filter cover with an air intake structure and face plate of a chainsaw and an additional seal squished between a mounting screw or lock, the filter body, and the intake structure.

Filter covers are often designed with aesthetics, rather than functional performance in mind. Accordingly, there needs to be a cover designed to complement the improved filter by incorporating enlarged interior airflow cavities, such that maximum intake airflow can be provided without compromising the function of the chainsaw components

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention.

FIG. 1 is a perspective view of an air filter system in accordance with an embodiment.

FIG. 2 is a front view of the air filter system of FIG. 1 in accordance with an embodiment.

FIG. 3 is a top view of the air filter system of FIG. 1 in accordance with an embodiment.

FIG. 4 is view of an inside of the air filter system of FIG. 1 in accordance with an embodiment.

FIG. 5 is a view of one side of the air filter system of FIG. 1 in accordance with an embodiment.

FIG. 6 is a view of an other side of the air filter system of FIG. 1 in accordance with an embodiment.

FIG. 7 is view of the air filter system of FIG. 1 from underneath in accordance with an embodiment.

FIG. 8 is a view of the section A as shown in FIG. 2.

FIG. 9 is a perspective view of the foam filter of the air filter system in accordance with an embodiment.

FIG. 10 is another perspective view of the foam filter of the air filter system in accordance with an embodiment.

FIG. 11 is an illustration of the filter cover with the improved air cavities and with a nut in accordance with an embodiment.

FIG. 12 is an illustration of the air filter system in use with a chainsaw plate in accordance with an embodiment.

FIG. 13 is a view of a detachable portion of a cage of the filter of the air filter system in accordance with an embodiment.

FIG. 14 is an illustration of a foam filter and a cage, which includes a detachable portion of the cage of the filter assembly in accordance with an embodiment.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

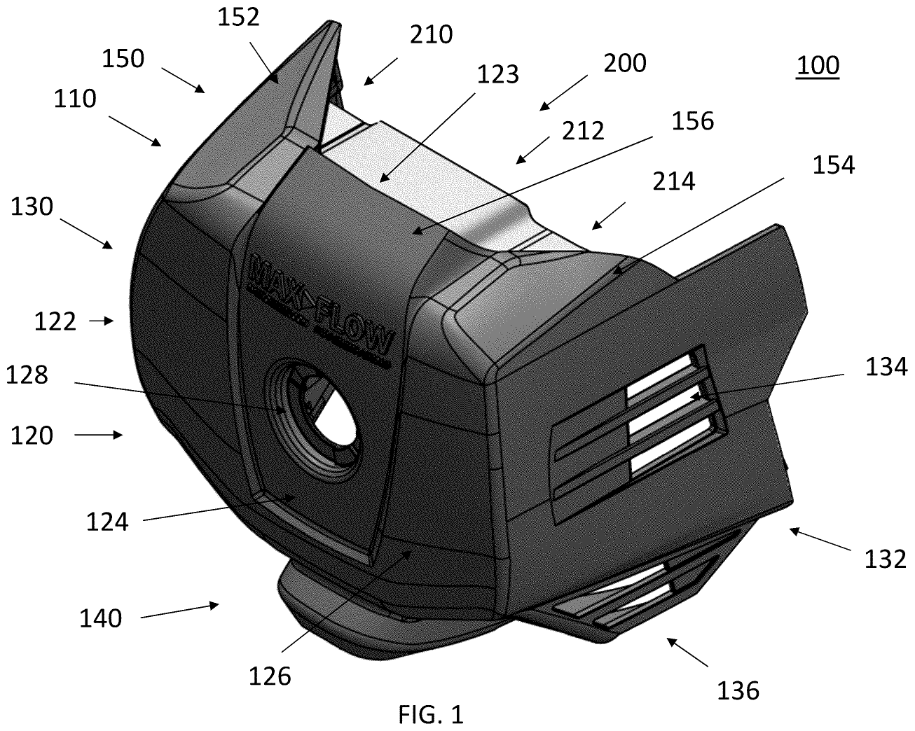

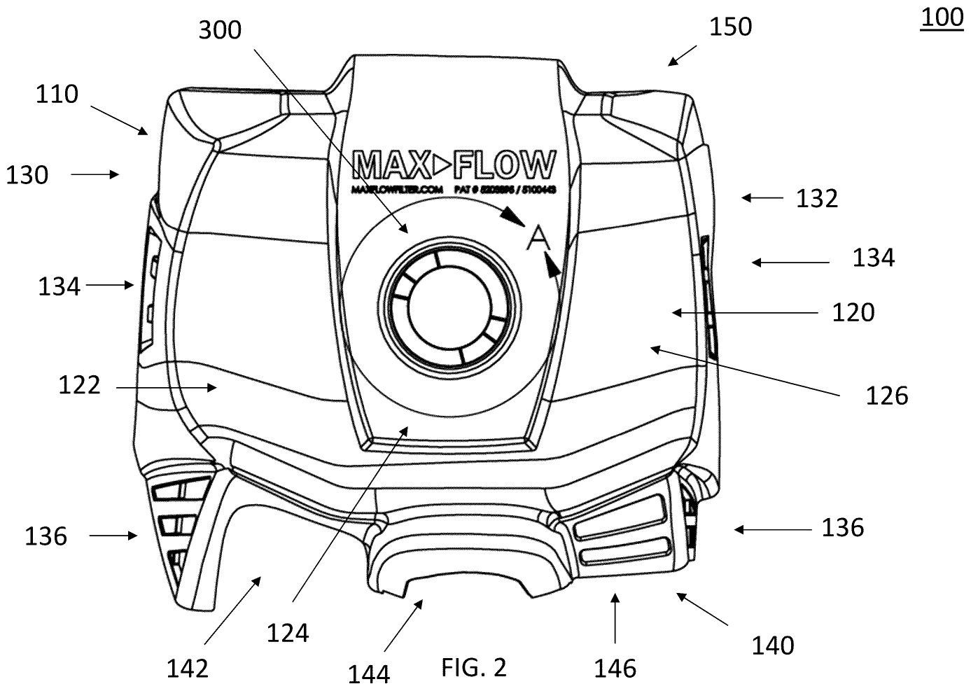

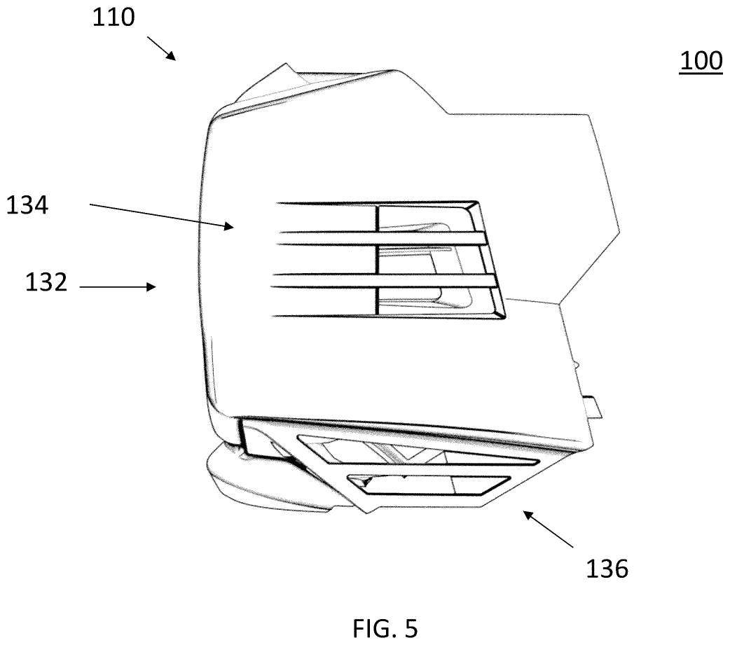

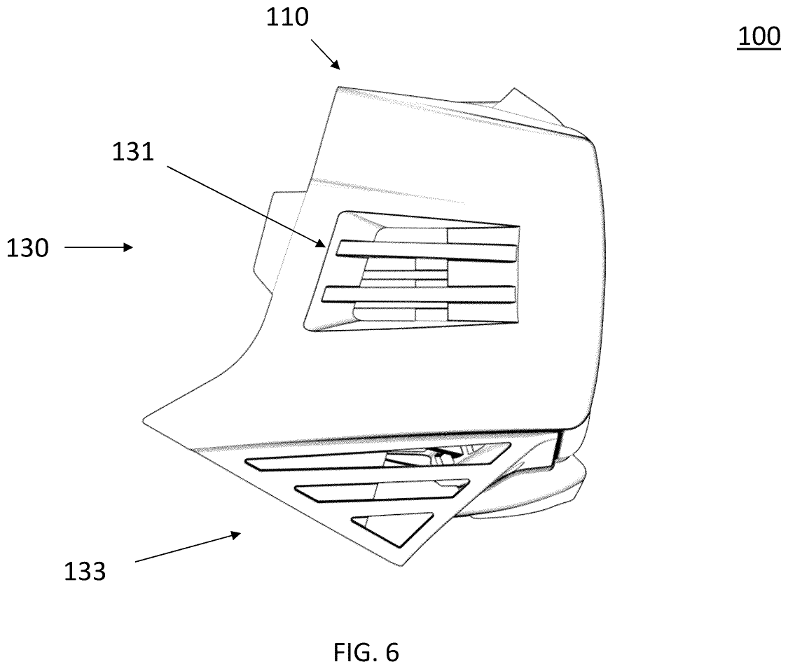

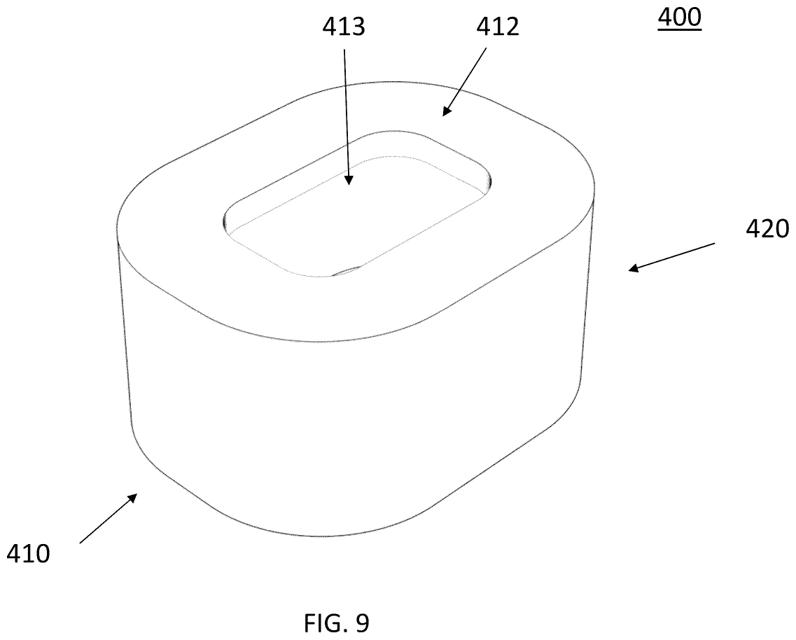

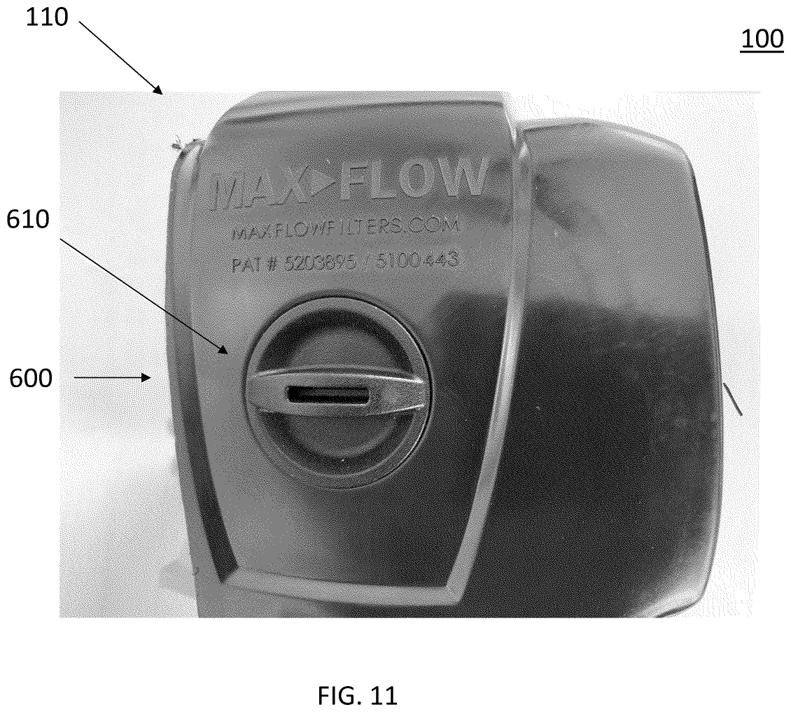

As shown in FIGS. 1-14, the air filter system (or filter assembly) 100 includes a cover 110 including an inner weather and debris protection baffle 200 (FIGS. 1-8), and a filter element 112 (FIGS. 9-14). The filter element 112 is configured to clean air for an engine, for example, of a chainsaw. The filter cover 110 includes a front panel 120, a pair of side panels 130, 132, a lower panel (or bottom panel) 140, and an upper panel (or top panel) 150. The front panel 120 can include a pair of side panels 122, 126, and a central panel 124 located between the pair of side panels 122, 126. The central panel 124 can be slightly recessed relative to the pair of side panels 122, 124. The central panel 124 can also include a recess 128 configured to receive a locking nut 600, for example, a ¼ turn nut (FIG. 11).

In accordance with an embodiment, the pair of side panels 130, 132 include one or more vents 131, 133, 134, 136, the one or more vents 131, 133, 134, 136 being arranged to extend in a direction away from the front panel 120.

In accordance with an embodiment, the lower panel 140 can include one or more cutouts 142, 144 configured to be received by the body of the chainsaw. In addition, the lower panel 140 can include one or more vents 146.

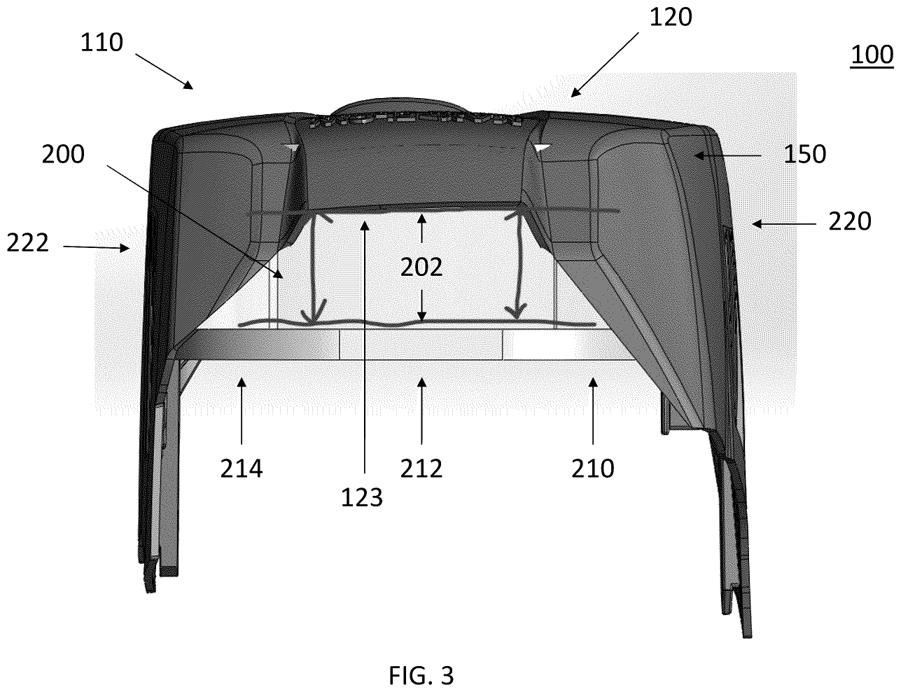

The upper panel can include a pair of outer portions 152, 154, and a center portion 156 extending from the front panel 120 with a rounded edge 123. The inner weather and debris protection baffle 200 provides protection and extends from underneath the upper panel 150. The inner weather and debris protection baffle 200 can have a width of at least equal to or greater than a width 202 (FIG. 3) of the upper panel 150 from an upper edge of the front panel 150 to a free end 123 of the upper panel 150. The width 202 of the inner weather and debris protection baffle 200 extends from underneath the upper panel 150 and away from the upper panel 150.

In accordance with an embodiment, the upper panel 150 has a first triangular shape 152 on one side and a second triangular shape 154 on an other side, the first triangular shape 152 being larger than the second triangular shape 154. The free end 123 of the upper panel 150 extends from the first triangular shape 152 to the second triangular shape 154 at an angle.

As shown in FIGS. 1 and 3, the inner weather and debris protection baffle 200 is located a distance from the free end 123 of the upper panel 150. The inner weather and debris protection baffle 200 can include a first outer portion 210, a second outer portion 214, and a center portion 212 located between the first outer portion 210 and the second outer portion 214, the center portion 212 being located closer to the free end 123 of the front panel 120 than the first outer portion 210 and the second outer portion 210.

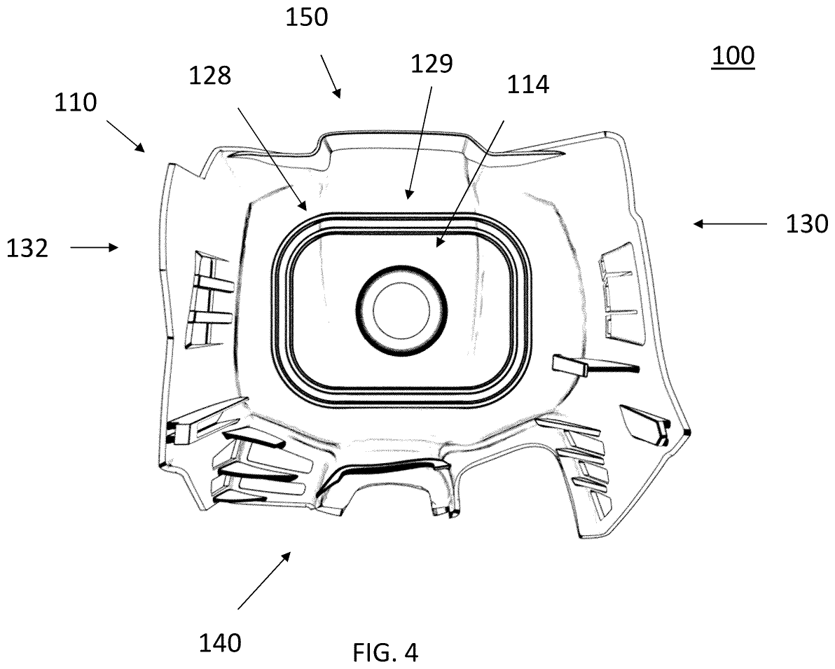

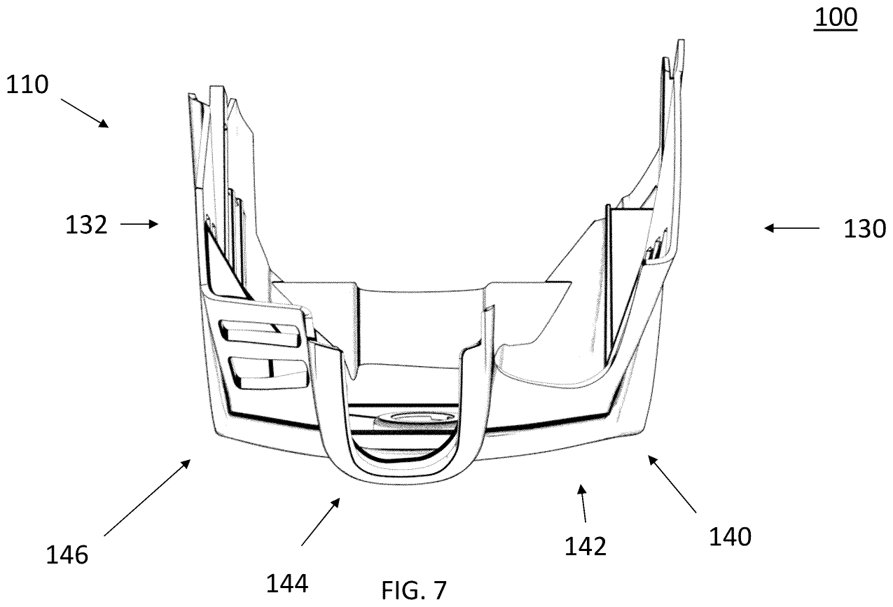

In accordance with an embodiment, the front panel 120, the pair of side panels 130, 132, the lower panel 140, and the upper panel 150 form a cavity 114 (FIGS. 4 and 7) configured to receive the filter element 112. As shown in FIG. 4, an inner side 128 of the front panel 120 includes a pair of raised edges 129 configured to engage the filter element 112. The pair of raised edges 129 can be, for example, in a rectangular shape with rounded edges.

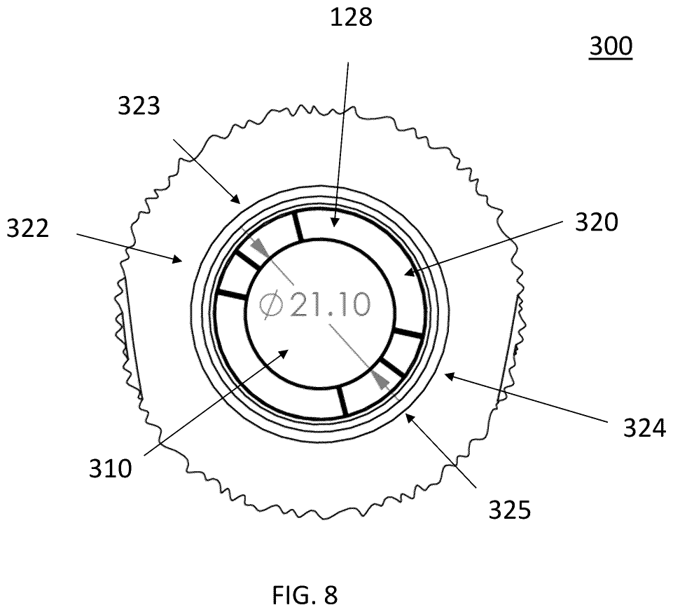

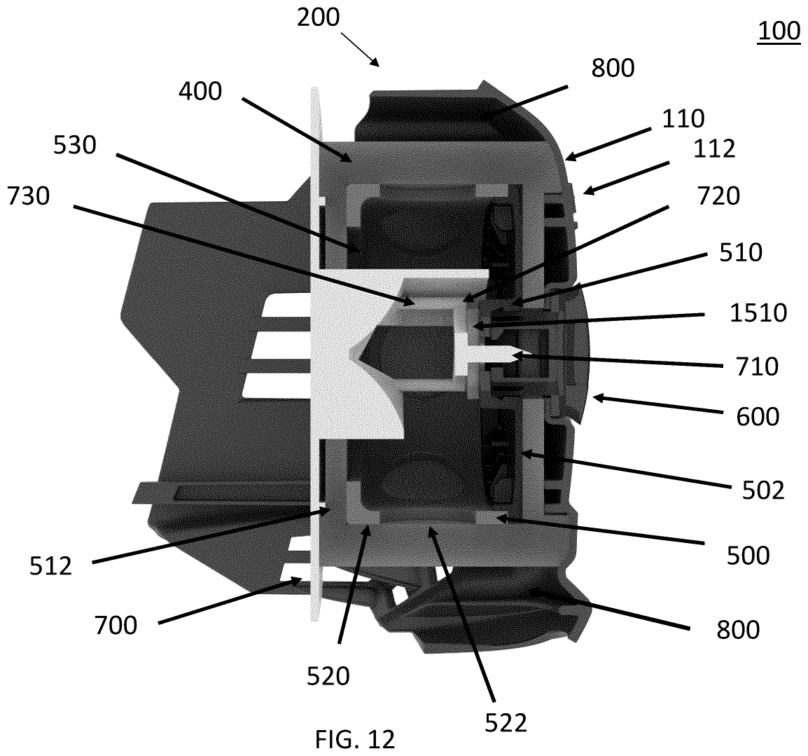

As shown in FIG. 8, the recess 128 includes an opening 310 surrounded by a flange 320 have a pair of recesses 322, 324, and a pair of protrusions 323, 325 configured to receive a nut 600. The pair of recesses 322, 324, and the pair of protrusions 323, 325 are configured to allow the nut 600 to rotate, for example, approximately 90 degrees (i.e., a ¼ turn) to secure the filter cover 110 to the filter assembly 112 and a chainsaw intake face plate 700 (FIG. 12). The pair of recesses 322, 324, and the pair of protrusions 323, 325 are arranged approximately 180 degrees from each other.

In accordance with an embodiment, the filter cover 110 can be molded as a single piece.

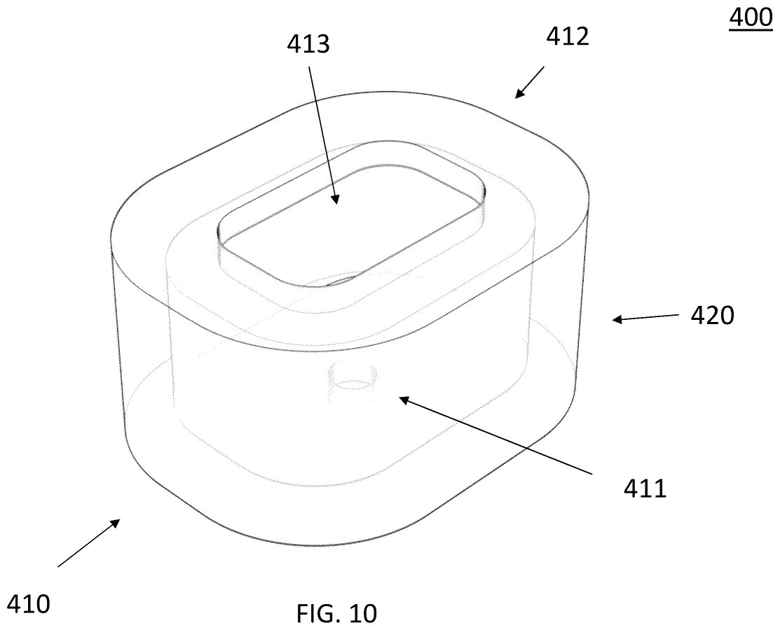

As shown in FIGS. 9 and 10, the foam element 400 of the filter element 112 includes opposed first and second spaced-apart endwalls 410, 412, and a sidewall 420 extending between the opposed first and second spaced-apart endwalls 410, 412. The first endwall 410 of the filter element 112 includes an opening 411 extending therethrough and the second endwall 412 including a flow passage 413 extending therethrough for providing fluid communication with an air outlet in a cage 500 (FIGS. 12-14) for supporting the foam element 400. The first endwall 410 preferably has a thickness sufficient for sealing the foam element 400 around a bolt or nut 600 passing through the hole 411 therein and the second endwall 412 having an inwardly extending section with a thickness sufficient for sealing the outer periphery of the flow passage. The foam element 400 can be a single piece of porous plastic foam material. In accordance with an embodiment, the foam element 400 can be elliptical in a lateral cross section. In accordance with an embodiment, the foam element 400 can be replaced with a suitable filtering material.

FIG. 11 is an illustration of the filter cover 110 with a nut 600 in accordance with an embodiment. In accordance with an embodiment, the nut 600 includes a projection 610, and wherein the nut 600 rotates, for example, a ¼ turn to tighten the cover 110 to the filter element 112 and the chainsaw intake face plate 700 (FIG. 12) of the chainsaw.

FIG. 12 is an illustration of a locking nut 600 of the air filter system 100 illustrating a compaction or squish of the foam 400 of a filter element 112 in accordance with an embodiment. As shown in FIG. 12, one of the novelties of the air filter system 100 is the squish of an additional foam element 510 (incorrectly shown as SHOWN AS 1510) (i.e., donut squish) between the annular depression 540 of the cage lid 510 against the intake structure 730. As shown, the foam element 400 (i.e., green filter foam donut) is squished between the cage lid 510 and the cover 110 forming a first squish point. A second squish point occurs between cage 500 and the saw intake face plate 700. In addition, a third squish point, and which may be considered to be equally important, is the foam donut (or donut washer) 510 that is squished between the annular cavity 540 of the cage lid 510 and the saw intake structure 730, sealing the area around the saw intake stud. This third squish point helps stop any air migrating around the nut (or knob) 600 through the area of the saw intake stud 710 and then into the air intake of the saw.

As shown in FIG. 12, a plurality of high volume air cavities 800 are arranged around the foam 400 of the filter element 112. For example, as shown in FIG. 12, one high volume air cavity 800 is located above the filter element 112, and another high volume air cavity 800 is located beneath the filter element 112. In addition, enlarged air cavities are provided along both sides of the filter element 112 as well.

The cage 500 can include a sidewall 520 extending between a first endwall (or cage lid) 510 and a second endwall 512. The cage 500 can include an air inlet means and an air outlet means. In the preferred embodiment, the air inlet means comprises at least one opening 522 in the sidewall 520, and the air outlet means comprises a flow passage in the second endwall 522. The cage 500 also includes a flow passage 530 configured to engage the chainsaw intake face plate 700. Alternatively, the cage 500 could be substituted with a suitably shaped structure which does not include openings through one or more of the sidewall 510 and/or endwalls 520, 522. For instance, the cage 500 could comprise a paper or foam filter element.

In the preferred embodiment, the cage 500 is elliptical in shape and can include, for example, eight spaced-apart openings 522 in the sidewall 520. The openings can be separated by portions of the sidewall 520. Each of the openings 522 can have a diameter greater than one-half a distance between the first and second endwalls 510, 512. For example, the diameter of the holes can be three-fourths the distance between the endwalls 510, 512. The openings 522 can be separated from each other by a distance less than one-half the diameter of the openings.

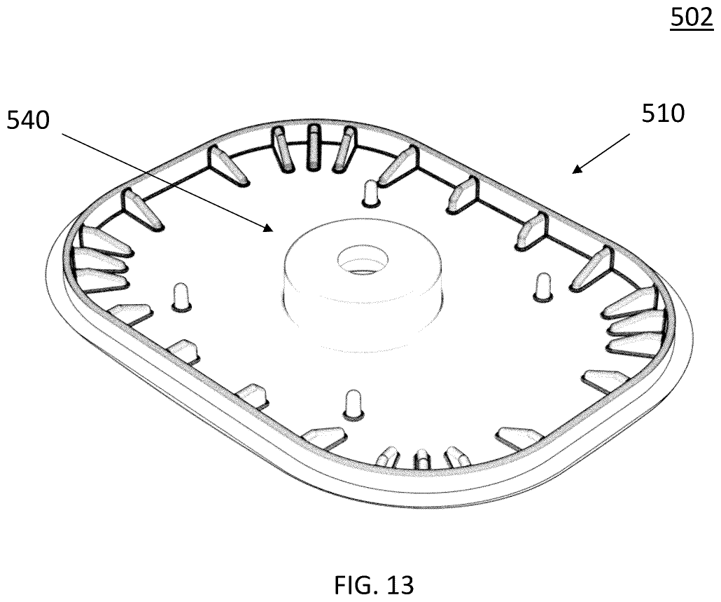

As shown in FIG. 13, the endwall (or cage lid) 510 can include an annular recess 540 configured to receive a portion of the locking nut (or mounting nut) 600 (FIG. 12), for example, a ¼ turn nut. In accordance with an embodiment, the cage lid 510 can be a detachable member (i.e., a detachable lid 502) that can be configured to accommodate different intake face plate(s) 700 and corresponding the intake stud 710 of the saw intake plate(s) 700. For example, the annular recess 540 can be an application specific annular recess configured to one or more specific chainsaws.

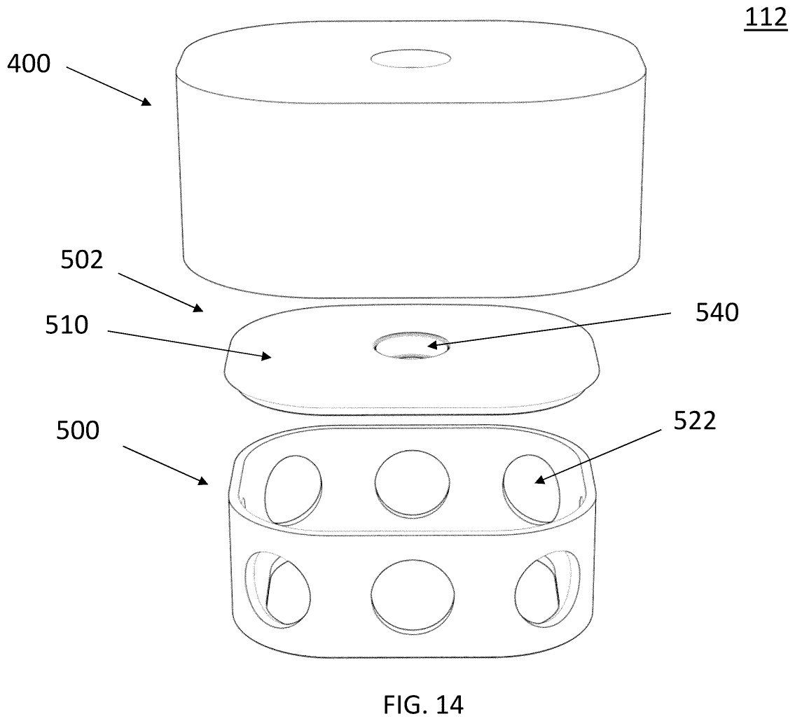

FIG. 14 is an illustration of the foam filter 400 and the cage 500, which includes a detachable portion 502 of the cage 500 of the filter assembly 112 in accordance with an embodiment.

As shown in FIGS. 1-14, the air filter system (or filter assembly) 100 incorporates a variable height annular cavity 540 (VHAC) that can allow for precise compression of a foam (or filter foam) 400 at all the sealing edges of the foam 400 within the cover 110 and also the sealing area of the foam donut 510 against the intake structure 730 of the saw face plate 700. The cavity can be incorporated into the cage 500 or the detachable lid 510 on the cage 500. The VHAC works with the twist lock receptacle in the cover 110, which can provide, for example, a quarter turn locking of the locking nut (i.e., mounting nut) 600 on the installation stud of the saw while compressing the foam 400 between the sealing surfaces. The air filter system 100 as disclosed herein can also be used with a screw type mounting knob and stud.

In accordance with an embodiment, the cover 110 (i.e., chainsaw filter cover) is configured to work with the VHAC and includes unique high volume air cavities 800 to allow maximum air flow into and under the cover 110 without interfering with the flat bar-side profiles of the side panels 130, 132 that chainsaws require for cutting clearance. In addition, enlarged air cavities are provided along both sides of the element as well. The cover 110 also incorporates an engineered weather and debris baffle protection 200 which protects the filter element during harsh cutting conditions, while also providing unobstructed anti-vibration handle to chainsaw body clearance.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An air filter system comprising:
a filter configured to clean air for an engine of a chainsaw; and
a filter cover, the filter cover including a front panel, a pair of side panels, an upper panel, and a lower panel, the front panel including a recess configured to receive a locking nut, the upper panel including a pair of outer portions and a center portion extending from the front panel with a rounded edge, an inner weather and debris baffle extending from underneath the upper panel, and wherein the inner weather and debris baffle has a width of at least equal to or greater than a width of the upper panel from an upper edge of the front panel to a free end of the upper panel, the width of the inner lid extending from underneath the upper panel and away from the upper panel.

2. The air filter system according to claim 1, wherein the pair of side panels include one or more vents, the one or more vents being arranged to extend in a direction away from the front panel.

3. The air filter system according to claim 1, wherein the upper panel has a first triangular shape on one side and a second triangular shape on an other side, the first triangular shape being larger than the second triangular shape.

4. The air filter system according to claim 3, wherein the free end of the upper panel extends from the first triangular shape to the second triangular shape at an angle.

5. The air filter system according to claim 1, wherein the inner weather and debris baffle is located a distance from the free end of the upper panel.

6. The air filter system according to claim 1, wherein the inner weather and debris baffle includes a first outer portion, a second outer portion, and a center portion located between the first outer portion and the second outer portion, the center portion being located closer to the free end of the front panel than the first outer portion and the second outer portion.

7. The air filter system according to claim 1, wherein the inner weather and debris baffle is configured to slide freely under a cylinder head shroud located on a body of the chainsaw.

8. The air filter system according to claim 1, wherein the lower panel includes one or more cutouts configured to be received by a body of the chainsaw.

9. The air filter system according to claim 1, wherein the front panel, the pair of side panels, the upper panel, and the bottom panel form an enlarged air cavity configured to receive the filter.

10. The air filter system according to claim 1, wherein the filter cover is molded as a single piece.

11. The air filter system according to claim 1, wherein the filter includes a foam element having opposed first and second spaced-apart endwalls and a sidewall extending between the opposed first and second spaced-apart endwalls, the first endwall of the filter including a hole extending therethrough and the second endwall including a flow passage extending therethrough for providing fluid communication with an air outlet in a cage for supporting the foam element, the first endwall having a thickness sufficient for sealing the foam element around a locking nut passing through the hole in the foam element and the second endwall having an inwardly extending section with a thickness sufficient for sealing the outer periphery of the flow passage.

12. The air filter system according to claim 11, wherein the foam element comprises a single piece of porous plastic foam material.

13. The air filter system according to claim 11, wherein the foam element is elliptical in a lateral cross section.

14. The air filter system according to claim 11 wherein the cage incudes an application specific annular recess configured to receive a portion of the locking nut.

15. The air filter system according to claim 11, wherein the cage incudes a detachable application specific annular recess configured to receive a portion of the locking nut.

16. A method for filtering air for an engine of a chainsaw, the method comprising:
sealing a foam element against an inner surface of a filter cover, the sealing comprising squishing a foam material against one or more surfaces of the inner surface of the filter cover with an air intake structure and face plate of a chainsaw.

17. The method according to claim 16, wherein the sealing of the foam element against the inner surface of the filter cover further comprises:
squishing the foam material against a locking nut, the locking nut configured to secure the filter cover to the filter plate of the chainsaw; and
squishing the foam material between the filter cover and a cage, the foam material be wrapped around the cage.

18. The method according to claim 17, further comprising:
squishing a foam donut between the annular recess of a cage lid and an intake support structure of a face plate of the chainsaw to help stop air from migrating around the locking nut and into an air intake of the chainsaw.
